(19) United States
(12) Patent Application Publication
(10) Pub. No.: US 2023/0169350 A1
(43) Pub. Date: Jun. 1, 2023

(54) SPARSITY-INDUCING FEDERATED MACHINE LEARNING

(71) Applicant: QUALCOMM Incorporated, San Diego, CA (US)

(72) Inventors: Christos LOUIZOS, Amsterdam (NL); Hossein HOSSEINI, San Diego, CA (US); Matthias REISSER, Mountain View, CA (US); Max WELLING, Bussum (NL); Joseph Binamira SORIAGA, San Diego, CA (US)

(21) Appl. No.: 18/040,111

(22) PCT Filed: Sep. 28, 2021
(86) PCT No.: PCT/US2021/071633

§ 371 Date: Jan. 31, 2023

(30) Foreign Application Priority Data
Sep. 28, 2020 (GR) 20200100587

(51) Int. Cl. G06N 3/098

(52) U.S. Cl. CPC G06N 3/098

(57) ABSTRACT

Aspects described herein provide techniques for performing federated learning of a machine learning model, comprising: for each respective client of a plurality of clients and for each training round in a plurality of training rounds: generating a subset of model elements for the respective client based on sampling a gate probability distribution for each model element of a set of model elements for a global machine learning model; transmitting to the respective client: the subset of model elements; and a set of gate probabilities based on the sampling, wherein each gate probability of the set of gate probabilities is associated with one model element of the subset of model elements; receiving from each respective client of the plurality of clients a respective set of model updates; and updating the global machine learning model based on the respective set of model updates from each respective client of the plurality of clients.

### CROSS-REFERENCE TO RELATED APPLICATIONS

This Applications claims the benefit of and priority to Greek Patent Application No. 20200100587, filed Sep. 28, 2020, the entire contents of which are hereby incorporated by reference.

### INTRODUCTION

Aspects of the present disclosure relate to sparsity-inducing federated machine learning.

Machine learning is generally the process of producing a trained model (e.g., an artificial neural network, a tree, or other structures), which represents a generalized fit to a set of training data. Applying the trained model to new data produces inferences, which may be used to gain insights into the new data.

As the use of machine learning has proliferated in various technical domains for what are sometimes referred to as artificial intelligence tasks, the need for more efficient processing of machine learning model data has arisen. For example, “edge processing” devices, such as mobile devices, always on devices, internet of things (IoT) devices, and the like, have to balance the implementation of advanced machine learning capabilities with various interrelated design constraints, such as packaging size, native compute capabilities, power storage and use, data communication capabilities and costs, memory size, heat dissipation, and the like.

Federated learning is a distributed machine learning framework that enables a number of clients, such as edge processing devices, to train a shared global model collaboratively without transferring their local data to a remote server. Generally, a central server coordinates the federated learning process and each participating client communicates only model parameter information with the central server while keeping its local data private. This distributed approach helps with the issue of client device capability limitations (because training is federated), and also mitigates data privacy concerns in many cases.

Even though federated learning generally limits the amount of model data in any single transmission between server and client (or vice versa), the iterative nature of federated learning still generates a significant amount of data transmission traffic during training, which can be significantly costly depending on device and connection types. It is thus generally desirable to try and reduce the size of the data exchange between server and clients during federated learning. However, conventional methods for reducing data exchange have resulted in poorer performing models, such as when lossy compression of model data is used to limit the amount of data exchanged between the server and the clients.

Accordingly, there is a need for improved methods of performing federated learning where model performance is not compromised in favor of communications efficiency.

### BRIEF SUMMARY

Certain aspects provide a method for performing federated learning of a machine learning model, comprising: for each respective client of a plurality of clients and for each training round in a plurality of training rounds: generating a subset of model elements for the respective client based on sampling a gate probability distribution for each model element of a set of model elements for a global machine learning model; transmitting to the respective client: the subset of model elements; and a set of gate probabilities based on the sampling, wherein each gate probability of the set of gate probabilities is associated with one model element of the subset of model elements; receiving from each respective client of the plurality of clients a respective set of model updates; and updating the global machine learning model based on the respective set of model updates from each respective client of the plurality of clients.

Further aspects provide a method for performing federated learning of a machine learning model, comprising: receiving from a server managing federated learning of a global machine learning model: a subset of model elements from a set of model elements for the global machine learning model; and a set of gate probabilities, wherein each gate probability of the set of gate probabilities is associated with one model element of the subset of model elements; generating a set of model updates based on training a local machine learning model based on the set of model elements and the set of gate probabilities; and transmitting to the server a set of model updates.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example training flow for encouraging sparsity in federated learning.

FIG. 2 depicts an example method for performing sparsity-inducing federated learning.

FIG. 3 depicts another example method for performing sparsity-inducing federated learning.

FIG. 4 depicts an example processing system that may be configured to perform aspects of the federated learning methods described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for sparsity-inducing federated machine learning.

As machine learning models become more complex and thus larger, it is becoming increasingly difficult to train them on anything but high-power computers, such as servers. Federated learning is a distributed machine learning framework that enables a number of clients, including lower powered devices, such as edge processing devices, to train a shared global model collaboratively. In such a setting, it is generally desirable to reduce the client device computation along with overall communication costs. In particular, high communication costs might make federated learning through mobile data impractical.

One approach to address these issues is “federated dropout,” in which a server selects a specific probability of selecting a sub-model from the original model before the federated training process. Then, during the training process, the server stochastically selects and communicates to each client a random sub-model. Accordingly, instead of locally training an update to the whole global model, each client trains an update to a smaller sub-model. Because the sub-models are subsets of the global model, the local updates computed by the clients have a natural interpretation as updates to the larger global model.

Another approach is to modify messages from client to server for data transmission economy. For example, a client may select the top-k most informative elements from a message bound for the server and communicate only those k most informative elements to the server. Alternatively, a client may quantize its message before it is communicated to the server.

Embodiments described herein improve on existing approaches in multiple significant ways. First, unlike conventional federated dropout approaches, the methods described herein enable each client to automatically determine the appropriate sub-model of the original model in a way that fits its local dataset while also being as efficient as possible. Second, instead of the server sticking to one specific global probability over the sub-models, the global model can be optimized through client-specific probabilities.

### Federated Averaging Through the Lens of Expectation Maximization

As above, federated learning generally deals with the problem of learning a server model (e.g. a neural network) with parameters w, where may generally represent a vector, matrix, or tensor, from a dataset [symbol] ={(x₁, y₁), . . . , (x_{N}, y_{N})} of N datapoints that is distributed, potentially in a non-independent and identically distributed (IID) fashion, across S shards, i.e. [symbol] = [symbol] ₁ ∪ . . . ∪ [symbol] _{S}, without accessing the shard-specific datasets directly. Note that a shard may generally be a processing client participating in federated learning with a central server, and the shard may comprise a remote computer, server, mobile device, smart device, edge processing device, or the like. For simplicity, but without loss of generality, in the following it is assumed that all of the shards S have the same amount of data points; however, the framework can be extended to uneven amount of data points by choosing appropriate weighting factors. By defining a loss function [symbol] ( [symbol] ₛ; w) on each shard, the total loss can be written as:

$$arg {min}_{w} \frac{1}{S} {\sum }_{s = 1}^{S} {ℒ}_{s} ( {s}_{} , w ) , {ℒ}_{s} ( {𝒟}_{s} , w ) := \frac{1}{{N}_{s}} {\sum }_{i = 1}^{{N}_{s}} L ( {𝒟}_{si} ; w ) , \qquad ( 1 )$$

where Nₛ is the number of data points at shard (e.g., device) s and [symbol] ₛ is the dataset at device at shard s. Notably, this objective corresponds to empirical risk minimization (ERM) over the joint dataset [symbol] with a loss L(·) for each datapoint.

It is desirable to reduce the communication costs of federated learning. One approach for reducing communication during federated learning is to do multiple gradient updates for w in the inner optimization objective for each shard s, thus obtaining “local” models with parameters ϕₛ . These multiple gradient updates are denoted as “local epochs,” i.e. the number of passes through the entire local dataset, with an abbreviation of E. Each of the shards then communicates the local (or sub-)model ϕₛ to the server and the server updates the global model at “round” t by averaging the parameters of the local machine learning models, e.g., according to:

$${w}_{t} = \frac{1}{S} {\sum }_{s} {ϕ}_{s} . \qquad ( 2 )$$

This approach may be referred to as federated averaging.

While simple to implement, federated averaging can provide sub-optimal results on non-IID data, even though its convergence can be proved. Indeed, if the shards S have skewed distributions, then the average of the local machine learning model parameters might be a bad estimate for the global model. To combat this, a “proximal” term for the optimization at the shard level may be used that encourages the local machine learning models, ϕₛ, to be “close,” under some distance, to the model at the server, w. More formally this may be defined as:

$${ℒ}_{s} ( {𝒟}_{s} , w , {ϕ}_{s} ) := \frac{1}{{N}_{s}} {\sum }_{i = 1}^{{N}_{s}} L ( {si}_{} ; {ϕ}_{s} ) + \frac{λ}{2} {‖ {ϕ}_{s} - w ‖}^{2} , \qquad ( 3 )$$

where

$$\frac{λ}{2} {‖ {ϕ}_{s} - w ‖}^{2}$$

is the proximal term. After each of the shard-specific optimizations have finished, then the global model may be updated in a similar manner as federated averaging i.e. by averaging the shard specific parameters with Eq. 2.

### Connecting Federated Averaging with Expectation Maximization

Notably, the overall federated averaging algorithm is compatible with an optimization procedure based on a given objective function. For example, consider the following objective function:

$$arg {max}_{w} \frac{1}{S} {\sum }_{s = 1}^{S} log p ( {s}_{} \vert w ) , \qquad ( 4 )$$

where [symbol] ₛ corresponds to the shard-specific dataset that has Nₛ datapoints, P( [symbol] ₛ|w) corresponds to the likelihood of [symbol] ₛ under the server parameters w and Σₛ Nₛ=N. Now consider decomposing each of the shard specific likelihoods as follows:

p( [symbol] ₛ|w)=∫ p( [symbol] ₛ|ϕₛ)p(ϕₛ|w)dϕₛ, (5)

where an auxiliary latent variables ϕₛ is introduced, with the server parameters w acting as hyperparameters for the prior over the shard-specific parameters p(ϕₛ|w). These latent variables are the parameters of the local machine learning model at shard s, and the following convenient form for the prior can be used:

$$p ( {ϕ}_{s} \vert w ) ∝ exp ( - \frac{λ}{2} {‖ {ϕ}_{s} - w ‖}^{2} ) , \qquad ( 6 )$$

where λ acts as a regularization strength that prevents the ϕₛ from moving too far from w. Overall, this then leads to the following objective function:

$$arg {max}_{w} \frac{1}{S} {\sum }_{s = 1}^{S} log \int p ( {s}_{} \vert {ϕ}_{s} ) p ( {ϕ}_{s} \vert w ) {d ϕ}_{s} . \qquad ( 7 )$$

One way to optimize this objective in the presence of the latent variables ϕₛ is through Expectation-Maximization (EM). EM generally consists of two steps, the expectation step where the posterior distribution is formed over the latent variables:

$$p ( {ϕ}_{s} \vert {s}_{} , w ) = \frac{p ( {𝒟}_{s} \vert {ϕ}_{s} ) p ( {ϕ}_{s} \vert w )}{p ( {𝒟}_{s} \vert w )} , \qquad ( 8 )$$

and the maximization step where the probability of [symbol] ₛ is maximized with respect to the parameters of the model w by marginalizing over this posterior, such that:

$$arg {max}_{w} \frac{1}{S} {\sum }_{s} {𝔼}_{p ( {ϕ}_{s} \vert {𝒟}_{s} , {w}_{old} )} [ log p ( {s}_{} \vert {ϕ}_{s} ) + log p ( {ϕ}_{s} \vert w ) ] = arg {max}_{w} \frac{1}{S} {\sum }_{s} {𝔼}_{p ( {ϕ}_{s} \vert {𝒟}_{s} , {w}_{old} )} [ log p ( {ϕ}_{s} \vert w ) ] \qquad ( 9 )$$

Accordingly, if a single gradient step is performed for w in the maximization step, this procedure corresponds to doing gradient descent on the original objective of Eq. 7. To illustrate this, the gradient of Eq. 7 can be taken with respect to w where Zₛ=∫ p( [symbol] ₛ|ϕₛ)p(ϕₛ|w)dϕₛ, such that:

$$\frac{1}{S} {\sum }_{s} \frac{1}{{Z}_{s}} \int p ( {s}_{} \vert {ϕ}_{s} ) \frac{\partial p ( {ϕ}_{s} \vert w )}{\partial w} {d ϕ}_{s} = \qquad ( 10 )$$

$$\frac{1}{S} {\sum }_{s} \int \frac{p ( {𝒟}_{s} \vert {ϕ}_{s} ) p ( {ϕ}_{s} \vert w )}{{Z}_{s}} \frac{\partial log p ( {ϕ}_{s} \vert w )}{\partial w} {d ϕ}_{s} = \qquad ( 11 )$$

$$\frac{1}{S} {\sum }_{S} \int p ( {ϕ}_{s} \vert {𝒟}_{s} , w ) \frac{\partial log p ( {ϕ}_{s} \vert w )}{\partial w} {d ϕ}_{s} , \qquad ( 12 )$$

where to compute Eq. 12, the posterior distribution of the local variables ϕₛ must first be obtained and then the gradient for w is estimated by marginalizing over this posterior.

When posterior inference is intractable, hard-EM is sometimes employed. In such a case, “hard” assignment for the latent variables ϕₛ may be made in the expectation step by approximating p (ϕₛ| [symbol] ₛ) with its most probable point, for example:

$${ϕ}_{s}^{*} = arg {max}_{{ϕ}_{s}} \frac{p ( {𝒟}_{s} \vert {ϕ}_{s} ) p ( {ϕ}_{s} \vert w )}{p ( {𝒟}_{s} \vert w )} = arg {max}_{{ϕ}_{s}} log p ( {s}_{} \vert {ϕ}_{s} ) + log p ( {ϕ}_{s} \vert w ) . \qquad ( 13 )$$

This is usually easier to do using techniques such as stochastic gradient ascent. Given these hard assignments, the maximization step then corresponds to another simple maximization of:

$$arg {max}_{w} \frac{1}{S} {\sum }_{s} log p ( {ϕ}_{s}^{*} \vert w ) . \qquad ( 14 )$$

As a result, hard-EM corresponds to a block coordinate ascent type of algorithm on the following objective function:

$$arg {max}_{{ϕ}_{1 : S} , w} \frac{1}{S} {\sum }_{s} ( log p ( {s}_{} \vert {ϕ}_{s} ) + log p ( {ϕ}_{s} \vert w ) ) , \qquad ( 15 )$$

where optimizing the ϕ_{1:S} while keeping w fixed is alternated with optimizing w while keeping ϕ_{1:S} fixed.

By letting λ→0 in Equation 6, it is clear that the hard assignments in the expectation step mimics the process of optimizing a local machine learning model on each shard. In fact, even by optimizing the model locally with stochastic gradient descent for a fixed number of iterations with a given learning rate, a specific prior may be assumed over the parameters. For linear regression, this prior is a Gaussian centered at the initial value of the parameters whereas for nonlinear models it can be shown through the proximal view of each gradient descent iteration:

$${x}_{t + 1} : = arg {min}_{x} \{ f ( {x}_{t} ) + ∇ {f ( {x}_{t} )}^{T} ( x - {x}_{t} ) + \frac{1}{2 η} {‖ x - {x}_{r} ‖}^{2} \} , \qquad ( 16 )$$

that it imposes a similar Gaussian prior centered at the previous iterate with the learning rate η acting as the variance of that prior. After obtaining ϕₛ*, the maximization step then corresponds to:

$${argmax}_{w} {ℒ}_{r} : = \frac{1}{s} {\sum }_{s} - \frac{λ}{2} {‖ {ϕ}_{s}^{*} - w ‖}^{2} . \qquad ( 17 )$$

Then a closed form solution for this objective may be found by setting the derivative of the objective with respect to w to zero and solving for w according to:

$$\frac{\partial {ℒ}_{r}}{\partial w} = 0 ⇒ \frac{λ}{s} {\sum }_{s} ( {ϕ}_{s}^{*} - w ) = 0 ⇒ w = \frac{1}{s} {\sum }_{s} {ϕ}_{s}^{*} , \qquad ( 18 )$$

where the optimal solution for w given ϕ*_{1:S} is the same average of ϕ*_{1:S} that generated using federated averaging.

Federated averaging does not optimize the local parameters ϕ_{S} to convergence at each round. However, the alternating procedure of EM corresponds to block coordinate ascent on a single objective function, which is the variational lower bound of the marginal log-likelihoods. More specifically, the EM iterations perform block coordinate ascent to optimize the following objective:

$${argmax}_{{w}_{1 : S} , w} \frac{1}{S} {\sum }_{s} {𝔼}_{{q}_{{w}_{s}} ( {ϕ}_{s} )} [ log p ( {s}_{} \vert {ϕ}_{s} ) + log p ( {ϕ}_{s} \vert w ) - log {q}_{{w}_{s}} ( {ϕ}_{s} ) ] , \qquad ( 19 )$$

where wₛ are the parameters of the variational approximation to the posterior distribution p(ϕₛ| [symbol] ₛ, w). To obtain the procedure of federated averaging, up to a machine precision, a deterministic distribution for ϕₛ, ϕ_{w}_{ₛ}(ϕₛ)=δ(ϕₛ−wₛ) may be used, which would lead to the following simplification of the objective:

$${argmax}_{{ϕ}_{1 : S} , w} \frac{1}{S} {\sum }_{s} ( log p ( {s}_{} \vert {ϕ}_{s} ) + log p ( {ϕ}_{s} \vert w ) - C ) , \qquad ( 20 )$$

where C is a fixed constant independent of the parameters to be optimized. Notably, this objective is the same as the one at Eq. 15.

### Encouraging Sparsity in Federated Learning

An enhancement of federated averaging is to encourage sparsity via appropriate priors. Encouraging sparsity has two significant advantages: first, the model becomes smaller and thus it is easier, hardware-wise, to train on device; and second, it cuts down on communication costs as the pruned parameters do not need to be communicated.

A standard for sparsity in Bayesian models is the spike and slab prior. It is a mixture of two components, a delta spike at zero, κ(0), and a continuous distribution over the real line, i.e., the slab. More specifically, for a Gaussian slab it can be defined as:

p(x)=(1−π)δ(0)+π [symbol] (x|w, 1/λ), (21)

or equivalently as a hierarchical model:

p(x)=Σ_{z} p(z)p(x|z), p(z)=Bern(π), (22)

p(x|z=1)= [symbol] (x|w, 1/λ), p(x|z=0)=δ(0), (23)

where z plays a role of a “gating” variable that switches on or off the parameter w. Now consider using this distribution, instead of a single Gaussian, for the prior over the parameters in the federated setting. In this case, the hierarchical model will become:

p( [symbol] _{1:S}|w, θ)=Πₛ Σ_{z}_{ₛ} ∫ p( [symbol] ₛ|ϕₛ)p(ϕₛ|w, zₛ)p(zₛ|θ)dϕₛ, (24)

where w are the model weights at the server and θ are the probabilities of the binary gates. In a similar manner to federated averaging, hard-EM may be performed in order to optimize w, θ, with approximate distributions q(ϕₛ|zₛ)q(zₛ). The variational lower bound for this model can then be written as:

$${argmax}_{{w}_{1 : S} , w , {π}_{1 : S} , θ} \frac{1}{s} {\sum }_{s} {𝔼}_{{q}_{{π}_{s}} ( {z}_{s} ) {q}_{{w}_{s}} ( {ϕ}_{s} \vert {z}_{s} )} [ log p ( {s}_{} \vert {ϕ}_{s} ) + log p ( {ϕ}_{s} \vert w , {z}_{s} ) + log p ( {z}_{s} \vert θ ) - log {q}_{{w}_{s}} ( {ϕ}_{s} \vert {z}_{s} ) - log {q}_{{π}_{s}} ( {z}_{s} ) ] , \qquad ( 25 )$$

or equivalently as:

$${argmax}_{{w}_{1 : S} , w , {π}_{1 : S} , θ} \frac{1}{s} {\sum }_{s} {𝔼}_{{q}_{{π}_{s}} ( {z}_{s} ) {q}_{{w}_{s}} ( {ϕ}_{s} \vert {z}_{s} )} [ log p ( {s}_{} \vert {ϕ}_{s} ) ] - {𝔼}_{{q}_{{π}_{s}} ( {z}_{s} )} [ K L ( {q}_{{w}_{s}} ( {ϕ}_{s} \vert {z}_{s} ) ‖ p ( {ϕ}_{s} \vert w , {z}_{s} ) ) ] + {𝔼}_{{q}_{{π}_{s}} ( {z}_{s} )} [ log p ( {z}_{s} \vert θ ) - log {q}_{{π}_{s}} ( {z}_{s} ) ] , \qquad ( 26 )$$

For the shard specific weight distributions, as they are continuous, q(ϕₛᵢ|zₛᵢ=1): = [symbol] (ϕₛᵢ, ϵ), q(ϕₛᵢ|zₛᵢ=1): = [symbol] (0, ϵ) may be used with ϵ≈0 which will, up to machine precision, be deterministic, whereas for the gating variables, as they are binary, q_{π}_{ₛᵢ}(zₛᵢ): =Bern(πₛᵢ) may be used with πₛᵢ being the probability of activating local gate zₛᵢ where Bern(·) indicates a Bernoulli distribution. In order to do hard-EM for the binary variables, the entropy term for the q_{π}_{ₛ}(zₛ) may be removed from the aforementioned bound as this will encourage the approximate distribution to move towards the most probable value for zₛ. Furthermore, to arrive at a simple and intuitive objective at the shard level, the spike at zero may be relaxed to a Gaussian with precision λ₂, i.e. p(ϕₛᵢ|zₛᵢ=0)= [symbol] (0,1/λ₂). Taking all of these into account and by plugging in the appropriate expressions into Eq. 26, it can be shown that the local and global objectives will be:

$${argmax}_{{ϕ}_{s} {π}_{s}} {ℒ}_{s} ( {s}_{} , w , θ , {ϕ}_{s} , {π}_{s} ) := {𝔼}_{{q}_{{π}_{s}} ( {z}_{s} )} [ {\sum }_{i}^{{N}_{s}} L ( {s i}_{} , {ϕ}_{s} ⊙ {z}_{s} ) ] - λ {π}_{s} {‖ {ϕ}_{s} - w ‖}^{2} - {λ}_{0} {π}_{s} + {π}_{s} log θ + ( 1 - {π}_{s} ) log ( 1 - θ ) + C , \\ and \qquad ( 27 )$$

$${argmax}_{w , θ} ℒ := \frac{1}{s} {\sum }_{s = 1}^{s} {ℒ}_{s} ( {s}_{} , w , θ , {ϕ}_{s} , {π}_{s} ) \qquad ( 28 )$$

respectively, where

$${λ}_{0} = \frac{1}{2} log \frac{{λ}_{2}}{λ}$$

and C is a constant independent of the variables to be optimized. Notably, locally each shard optimizes the weights to be close to the server weights, regulated by the prior precision λ and the probability of keeping that weight locally πₛ, while explaining [symbol] ₛ as much as possible. Furthermore, the gate activation probabilities are being optimized to be close to the server θ with an additional term that penalizes the sum of the local activation probabilities. This is similar to the L₀ regularization objective that has been previously proposed.

Now it may be considered what happens at the server after the local shard, through some procedure, optimizes ϕₛ and πₛ. Since the server loss for w, θ is just the sum of all of the local losses, the gradient for each of the parameters will be:

$$\frac{\partial ℒ}{\partial w} = {\sum }_{s} λ {π}_{s} ( {ϕ}_{s} - w ) , \\ \frac{\partial ℒ}{\partial θ} = {\sum }_{s} ( \frac{{π}_{s}}{θ} - \frac{1 - {π}_{s}}{1 - θ} ) . \qquad ( 29 )$$

Setting these derivatives to zero, the stationary points are:

$$w = \frac{1}{{\sum }_{s} {π}_{s}} {\sum }_{s} {π}_{s} {ϕ}_{s} , \\ θ = \frac{1}{s} {\sum }_{s} {π}_{s} , \qquad ( 30 )$$

i.e., a weighted average of the local weights and an average of the local probabilities of keeping these weights. Therefore, since the πₛ are being optimized to be sparse through the L₀ penalty, the server probabilities θ will also become sparse for the weights that are not used by any of the shards. As a result, to obtain the final sparse architecture, the weights can be pruned where their server inclusion probabilities θ are less than a threshold, such as 0.1, though other thresholds are possible.

### Local Optimization

While optimizing for ϕₛ locally is straightforward to do with gradient-based optimizers, πₛ is less straightforward, as the expectation over the binary variables zₛ in Eq. 27 is intractable to compute in closed form and using Monte-Carlo integration does not yield reparametrizable samples. To circumvent these issues, the objective may be rewritten in an equivalent form as:

$${ℒ}_{s} ( {s}_{} , w , θ , {ϕ}_{s} , {π}_{s} ) := {𝔼}_{{q}_{{π}_{s}} ( {z}_{s} )} [ {\sum }_{i}^{{N}_{s}} L ( {s i}_{} , {ϕ}_{s} ⊙ {z}_{s} ) - λ [ {z}_{s} \neq 0 ] {‖ {ϕ}_{s} - w ‖}^{2} - {λ}_{0} [ {z}_{s} \neq 0 ] + [ {z}_{s} \neq 0 ] log \frac{θ}{1 - θ} + log ( 1 - θ ) ] , \qquad ( 31 )$$

and then the Bernoulli distribution q_{π}_{ₛ}(zₛ) may be replaced with a continuous relaxation, such as the hard-Concrete distribution. Let the continuous relaxation be rᵥ_{ₛ}(zₛ), where vₛ are the parameters of the surrogate distribution. In this case the local objective will become:

$${ℒ}_{s} ( {s}_{} , w , θ , {ϕ}_{s} , {V}_{s} ) := {𝔼}_{{r}_{{v}_{s}} ( {z}_{s} )} [ {\sum }_{i}^{{N}_{s}} L ( {s i}_{} , {ϕ}_{s} ⊙ {z}_{s} ) ] - λ {R}_{{v}_{s}} ( {z}_{s} > 0 ) {‖ {ϕ}_{s} - w ‖}^{2} - {λ}_{0} {R}_{{v}_{s}} ( {z}_{s} > 0 ) + {R}_{{v}_{s}} ( {z}_{s} > 0 ) log \frac{θ}{1 - θ} + log ( 1 - θ ) , \qquad ( 32 )$$

where Rᵥ_{ₛ}(·) is the cumulative distribution function (CDF) of the continuous relaxation rᵥ_{ₛ}(·). Therefore, now the surrogate objective can be straightforwardly optimized with gradient descent.

### Reducing the Client to Server Communication Cost

The model described above allows learning a sparse model for inference at the server. The same framework may be used to cut down the communication costs during training time by employing two techniques that reduce the communication cost for the client-to-server and server-to-client communication respectively.

In order to reduce the client to server cost, sparse samples may be communicated from the local distributions instead of the distributions themselves. For example, instead of sending the local weights ϕₛ and the local probabilities πₛ to the server, the client can instead draw a random binary sample zₛ ∈ {0, 1} according to πₛ and then only communicate the weights ϕₛᵢ which have zₛᵢ=1 to the server, along with the zₛ. In this way, the zero values of the parameter vector do not have to be communicated, which leads to meaningful savings, while still keeping the server gradient unbiased. More specifically, the gradients and stationary points for the server weights may be expressed as follows:

$$\frac{\partial ℒ}{\partial w} = {\sum }_{s} {λ𝔼}_{{q}_{{π}_{s}} ( {z}_{s} )} [ [ {z}_{s} \neq 0 ] ( {ϕ}_{s} - w ) ] \qquad ( 33 )$$

$$w = {𝔼}_{{q}_{{π}_{1 : S}}} ( {z}_{1 : S} ) \frac{1}{{\sum }_{j} [ {z}_{j} \neq 0 ]} {\sum }_{s} [ {z}_{s} \neq 0 ] {ϕ}_{s} , \qquad ( 34 )$$

whereas for the expressions for the server probabilities are:

$$\frac{\partial ℒ}{\partial θ} = {\sum }_{s} {𝔼}_{{q}_{{π}_{s}} ( {z}_{s} )} [ \frac{[ {z}_{s} \neq 0 ]}{θ} - \frac{[ {z}_{s} = 0 ]}{1 - θ} ] \qquad ( 35 )$$

$$θ = \frac{1}{s} {\sum }_{s} {𝔼}_{{q}_{{π}_{s}} ( {z}_{s} )} [ [ {z}_{s} \neq 0 ] ] . \qquad ( 36 )$$

As a result, the client may communicate only a subset of the local weights \hat{ϕ}ₛ via zₛ˜q_{π}_{ₛ}(zₛ), \hat{ϕ}ₛ=ϕₛ ⊙ zₛ. In this way, the client communicates the subset of local weights along with the zₛ. Having access to those samples, it can then form 1-sample stochastic estimates of either the gradients or the stationary points for w, θ. As locally, the client operates on a smoothed objective that uses a hard-Concrete relaxation rᵥ_{ₛ}(zₛ), \hat{ϕ}ₛ may be formed by sampling from a zero temperature rᵥ_{ₛ}(zₛ) whenever a client communicates to the server, thus obtaining exact discrete samples zₛ.

Notice that this is a way to reduce communication, without adding bias in the gradients of the original objective. In cases where incurring extra bias is acceptable, further techniques, such as quantization and top-k gradient selection may be used to reduce communication even further.

### Reducing the Server to Client Communication Cost

The server needs to communicate to the clients the updated distributions at each round. Unfortunately, for simple unstructured pruning, this doubles the communication cost as for each weight wᵢ there is an associated θᵢ that needs to be sent to the client. To mitigate this effect, structured pruning may be employed, which introduces a single additional parameter indicating the probability for each group of weights, and is thus more efficient with respect to the number of trainable parameters compared to unstructured pruning. Even with structured pruning, the normal weights and probabilities are sent to the server (except in the case of communicating sparse samples, as above, but with structured pruning the probability vector is significantly smaller). Thus, for groups of moderate sizes, e.g., the set of weights of a given convolutional filter, the extra overhead is relatively small.

The communication cost reductions can also be taken one step further if some bias is allowed for in the optimization procedure. For example, the global model may be pruned during training after every round and thus send to each of the clients only the subset of the model that has survived. Notably, this is efficient to perform and does not require any data at the server, since it has access to the inclusion probabilities θ and thus the parameters that have θ less than a threshold, e.g., 0.1, can be removed. This can lead to substantial reductions in the communication costs, especially during the later stages of training where the model is sparser.

An additional way to reduce the communication cost would be for the client to perform local pruning and thus only request from the server the subset of the original model parameters that will survive locally.

Accordingly, when performing federated learning, a generalization of federated averaging may be used to optimize for sparse neural networks, which subsequently leads to significant communication savings while maintaining similar performance.

### Example Training Flow for Encouraging Sparsity in Federated Learning

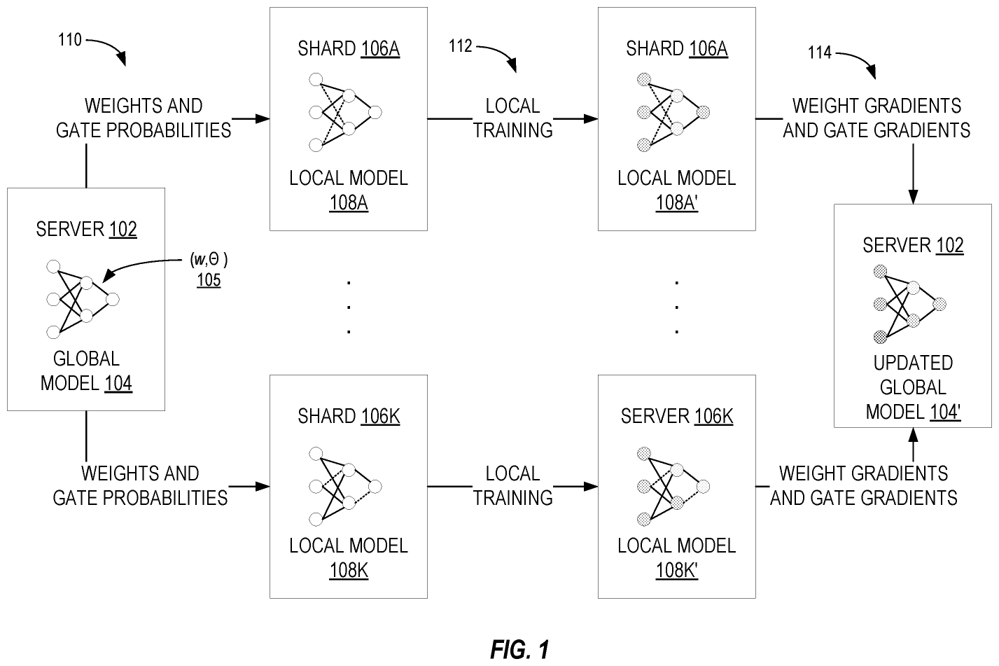

FIG. 1 depicts an example training flow for encouraging sparsity in federated learning, as described in conceptual detail above.

Initially, server 102 generates or maintains a global model 104 in a first state. In this example, each of the edges between the nodes in global model 104 is associated with parameters, including a weight w and a gate probability θ (e.g., parameter set 105). As above, the gate probability generally represents the likelihood that that associated weight will be included in local (or sub-) models for federated training.

At 110, server 102 samples the global model weights w according to their associated gate probabilities θ in order to generate various subsets of weights and gate probabilities for each of shards 106A-K, where each shard may be representative of a client device participating in federated learning with server 102.

Based on this information, each shard 106A-K, where K is the total number of shards participating in the federated learning, generates a local machine learning model 108A-K with parameters ϕₛ, πₛ based on the parameters received from server 102, where s is a specific shard in the set S of shards. In FIG. 1, dotted lines between nodes in local machine learning models 108A-K indicate weights that are gated off and thus not included in the local machine learning model training.

As depicted, the local machine learning model is generally different for each shard based on the different gate probabilities and the random sampling performed by server 102. This helps to increase the comprehensiveness of the federated training.

At 112, each shard 106A-K trains its local machine learning model 108A-K, respectively, and generates an updated local machine learning model 108A′-K′. Further, each shard 106A-K generates weight gradients and gate gradients based on the training, for example, as described above with respect to Equations 31 and 32.

At 114, each shard 106A-K trasmits model update data back to server 102. Then server 102 uses the model update data to generate an updated global model 104′. In the depicted embodiment, the model update data sent by each shard 106A-K includes weight gradients and gate gradients for each element of the shard's local machine learning model (e.g., 108A′-K′).

Notably, FIG. 1 depicts a single round of training for simplicity, and this process may be repeated iteratively any number of times until, for example, a training target is reached (e.g., a number of iterations is complete, the weights converge, an accuracy threshold is reached, etc.).

After the federated training ends (e.g., when the global model 104 converges) it possible that one or more nodes (in a neural network model example) are effectively gated off permanently (not depicted in FIG. 1). More generally, the pruning rate of the global model 104 may gradually be increased during training such that by end of training, the model may be very sparse (e.g., ˜90% sparsity rate). For example, a 90% sparsity rate of the trained global model 104′ in the context of FIG. 1 would mean that 90% of the weights are pruned away during training based on the set thresholds.

Notably, in this example, sparsity is induced in the weights on the edges between nodes of the example model, but in other examples, other aspects of a model may be associated with gate probabilities in order to induce alternative or additional sparsity. For example, nodes or layers in a model might be associated with gate probabilities and therefore sampled and pruned during federated training. As another example, in the context of a convolutional neural network model, individual filter channels may be associated with gate probabilities and therefore sampled and pruned to induce sparsity during training.

In addition to the sparsity induced during training based on gate probabilities, further strategies may be implemented to reduce communications costs. As above, in order to reduce the shard (or client) to server communication cost (e.g., at step 114), only the gradients for the aspects of the model not gated off (e.g., the weights represented by solid lines between nodes in FIG. 1) are communicated back to the server during each training round. So unlike conventional federated learning where all weights are transmitted between shard and server in each training round, here it is possible so save communication time and cost can by sending only a subset of the model data corresponding to that which is updated by each local machine learning model 108A-K during local training.

Further, each shard (e.g., 106A-K) can sample elements of the local machine learning model (e.g., 108A-K) according to gate probabilities πₛ. So, for example, instead of sending the entire set of weight gradients (for a local machine learning model's parameters ϕₛ) and the gate gradient (for local gate probabilities πₛ), a shard may either sends the weight update and z=1 or send nothing (corresponding to z=0), where, as above, z is a “gating” variable. Thus, z is a value in {0, 1} and π is the probability of having z=1 and 1−π is the probability of having z=0.

This helps to reduce the communication cost between each shard and server 102 at step 114. In such as case, the server update rule may be modified from equation (30) to equations (34) and (36) for updating weights w and probabilities for binary gates, respectively.

### Example Methods of Performing Federated Learning

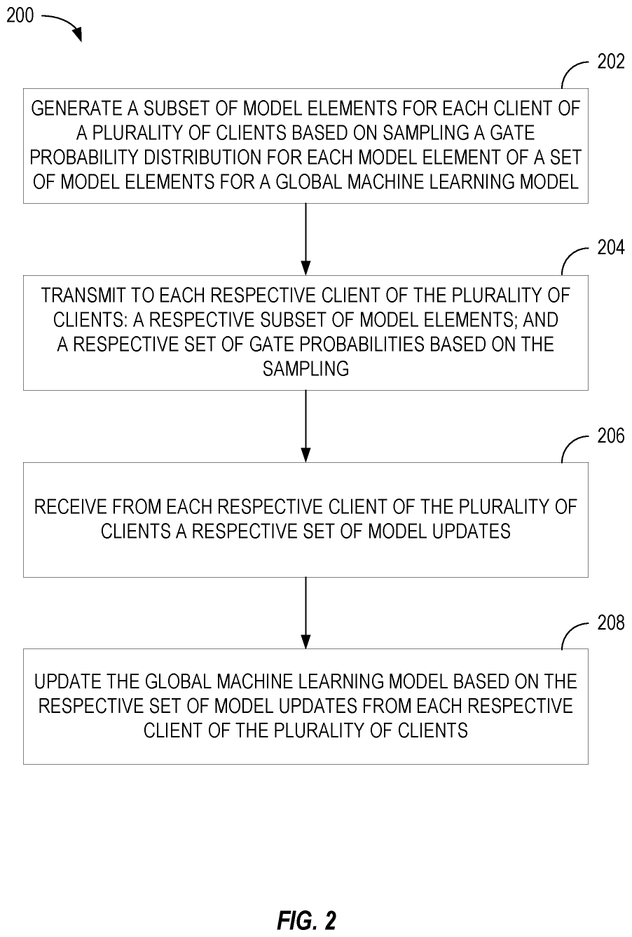

FIG. 2 depicts an example method 200 for performing sparsity-inducing federated learning, which may be performed, for example, by a federated learning server, such as 102 in FIG. 1.

Method 200 begins at step 202 with generating a subset of model elements for each client of a plurality of clients (e.g., shards 106A-K in FIG. 1) based on sampling a gate probability distribution for each model element of a set of model elements for a global machine learning model.

In some embodiments of method 200, the subset of model elements comprises a subset of weights associated with edges connecting nodes in the global machine learning model. In some embodiments of method 200, the subset of model elements comprises a subset of nodes in the global machine learning model. In some embodiments of method 200, the subset of model elements comprises a subset of channels in a convolution filter of the global machine learning model.

Method 200 then proceeds to step 204 with transmitting to the each respective client of the plurality of clients: the subset of model elements; and a set of gate probabilities based on the sampling, wherein each gate probability of the set of gate probabilities is associated with one model element of the subset of model elements (e.g., such as described in step 110 with respect to FIG. 1).

Method 200 then proceeds to step 206 with receiving from each respective client of the plurality of clients a respective set of model updates (e.g., such as described in step 114 with respect to FIG. 1).

Method 200 then proceeds to step 208 with updating the global machine learning model based on the respective set of model updates from each respective client of the plurality of clients.

In some embodiments of method 200, the respective set of model updates comprises: a set of weight gradients associated with a local machine learning model trained by the respective client; and a set of gate probability gradients associated with the local machine learning model trained by the respective client.

In some embodiments of method 200, the respective set of model updates comprises: a set of weight gradients associated with a local machine learning model trained by the respective client; and a binary gate variable value associated with each weight gradient of the set of weight gradients.

In some embodiments of method 200, updating the global machine learning model based on the respective set of model updates from each respective client of the plurality of clients further comprises: pruning the updated global machine learning model based on updated gate probabilities for the global machine learning model and a threshold gate probability value.

Notably, FIG. 2 is just one example of a model consistent with the disclosure herein, and further examples are possible, with additional, fewer, and/or additional steps.

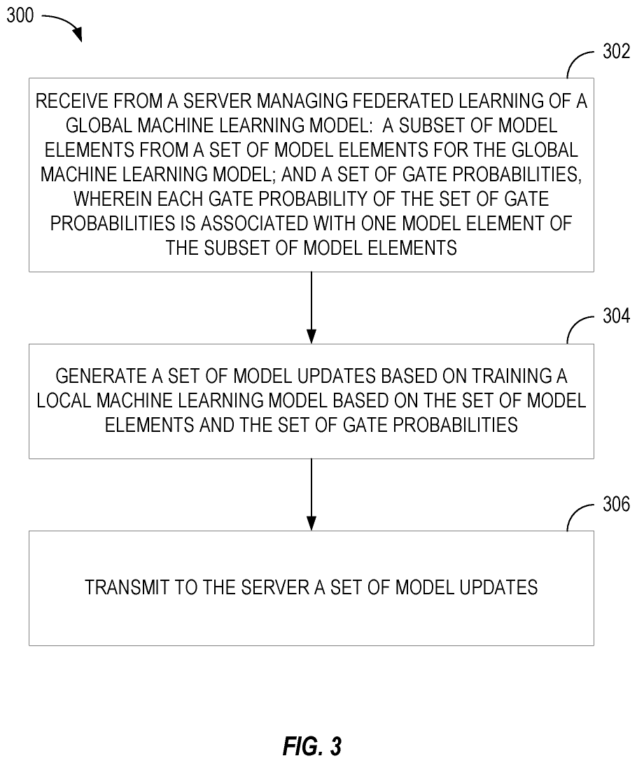

FIG. 3 depicts another example method 300 for performing sparsity-inducing federated learning, which may be performed, for example, by a federated learning client, such as 106A-K in FIG. 1.

Method 300 begins at step 302 with receiving from a server managing federated learning of a global machine learning model: a subset of model elements from a set of model elements for the global machine learning model; and a set of gate probabilities, wherein each gate probability of the set of gate probabilities is associated with one model element of the subset of model elements.

In some embodiments of method 300, the subset of model elements comprises a subset of weights associated with edges connecting nodes in the global machine learning model. In some embodiments of method 300, the subset of model elements comprises a subset of nodes in the global machine learning model. In some embodiments of method 300, the subset of model elements comprises a subset of channels in a convolution filter of the global machine learning model.

Method 300 then proceeds to step 304 with generating a set of model updates based on training a local machine learning model based on the set of model elements and the set of gate probabilities (e.g., such as described in step 112 with respect to FIG. 1).

Method 300 then proceeds to step 306 with transmitting to the server a set of model updates (e.g., such as described in step 114 with respect to FIG. 1).

In some embodiments of method 300, the set of model updates comprises: a set of weight gradients associated with the local machine learning model; and a set of gate probability gradients associated with the local machine learning model (e.g., local machine learning models 108A-K in FIG. 1).

In some embodiments of method 300, the set of model updates comprises: a set of weight gradients associated with the local machine learning model; and a binary gate variable value associated with each weight gradient of the set of weight gradients.

In some embodiments, method 300 further includes receiving a final set of model elements from the server, wherein the final set of model elements corresponds to a pruned global machine learning model.

Notably, FIG. 3 is just one example of a model consistent with the disclosure herein, and further examples are possible, with additional, fewer, and/or additional steps.

### Example Processing System

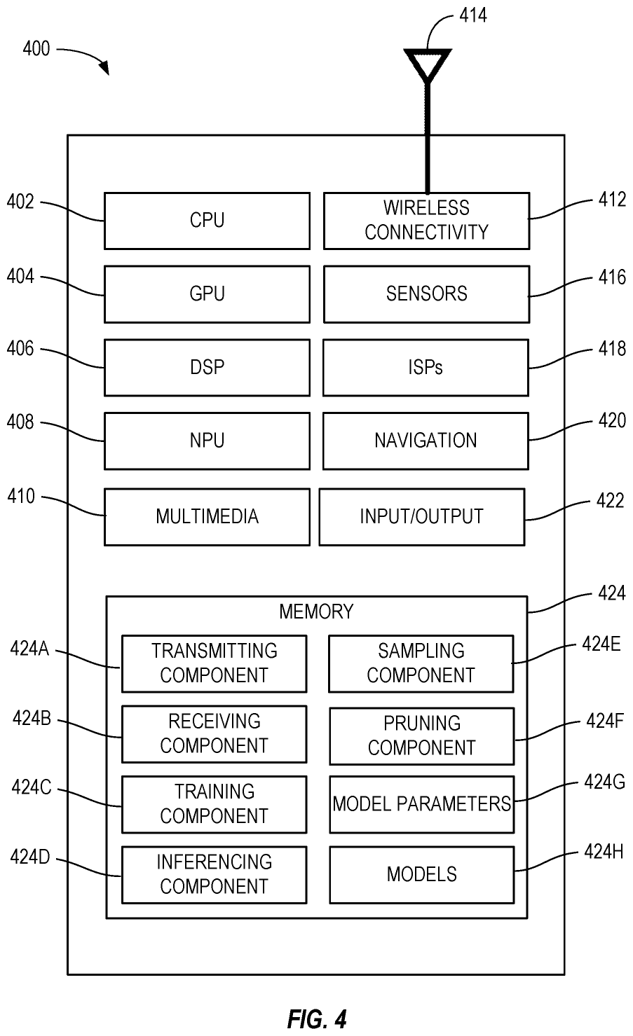

FIG. 4 depicts an example processing system 400 that may be configured to perform aspects of the federated learning methods described herein, including, for example, methods 200 and 300 of FIGS. 2 and 3, respectively.

Processing system 400 includes a central processing unit (CPU) 402, which in some examples may be a multi-core CPU. Instructions executed at the CPU 402 may be loaded, for example, from a program memory associated with the CPU 402 or may be loaded from a memory 424.

Processing system 400 also includes additional processing components tailored to specific functions, such as a graphics processing unit (GPU) 404, a digital signal processor (DSP) 406, a neural processing unit (NPU) 408, a multimedia processing unit 410, and a wireless connectivity component 412.

An NPU, such as 408, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), or vision processing unit (VPU).

NPUs, such as 408, may be configured to accelerate the performance of common machine learning tasks, such as image classification, sound classification, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 408 is a part of one or more of CPU 402, GPU 404, and/or DSP 406.

In some examples, wireless connectivity component 412 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 412 is further connected to one or more antennas 414.

Processing system 400 may also include one or more sensor processing units 416 associated with any manner of sensor, one or more image signal processors (ISPs) 418 associated with any manner of image sensor, and/or a navigation processor 420, which may include satellite-based positioning system components (e.g., GPS or GLONASS) as well as inertial positioning system components.

Processing system 400 may also include one or more input and/or output devices 422, such as screens, touch-sensitive surfaces (including touch-sensitive displays), physical buttons, speakers, microphones, and the like.

In some examples, one or more of the processors of processing system 400 may be based on an ARM or RISC-V instruction set.

Processing system 400 also includes memory 424, which is representative of one or more static and/or dynamic memories, such as a dynamic random access memory, a flash-based static memory, and the like. In this example, memory 424 includes computer-executable components, which may be executed by one or more of the aforementioned processors of processing system 400.

In this example, memory 424 includes transmitting component 424A, receiving component 424B, training component 424C, inferencing component 424D, sampling component 424E, pruning component 424F, model parameters 424G (e.g., weights and gate probabilities, as discussed above), and models 424H. The depicted components, and others not depicted, may be configured to perform various aspects of the methods described herein.

Processing system 400 is just one example and may generally perform the operations of the server and/or clients/shards described herein. However, in other embodiments, certain aspects may be omitted. For example, a server may omit certain features that may be regularly found in a mobile device, such as multimedia component 410, wireless connectivity component 412, antenna 414, sensors 416, ISPs 418, and navigation component 420. The depicted example is not meant to be limiting.

### Example Clauses

Implementation examples are described in the following numbered clauses:

Clause 1: A method for performing federated learning of a machine learning model, comprising: for each respective client of a plurality of clients and for each training round in a plurality of training rounds: generating a subset of model elements for the respective client based on sampling a gate probability distribution for each model element of a set of model elements for a global machine learning model; transmitting to the respective client: the subset of model elements; and a set of gate probabilities based on the sampling, wherein each gate probability of the set of gate probabilities is associated with one model element of the subset of model elements; receiving from each respective client of the plurality of clients a respective set of model updates; and updating the global machine learning model based on the respective set of model updates from each respective client of the plurality of clients.

Clause 2: The method of Clause 1, wherein the subset of model elements comprises a subset of weights associated with edges connecting nodes in the global machine learning model.

Clause 3 : The method of Clause 2, wherein the respective set of model updates comprises: a set of weight gradients associated with a local machine learning model trained by the respective client; and a set of gate probability gradients associated with the local machine learning model trained by the respective client.

Clause 4: The method of Clause 2, wherein the respective set of model updates comprises: a set of weight gradients associated with a local machine learning model trained by the respective client; and a binary gate variable value associated with each weight gradient of the set of weight gradients.

Clause 5: The method of any one of Clauses 1-4, wherein the subset of model elements comprises a subset of nodes in the global machine learning model.

Clause 6: The method of any one of Clauses 1-5, wherein the subset of model elements comprises a subset of channels in a convolution filter of the global machine learning model.

Clause 7: The method of any one of Clauses 1-6, wherein updating the global machine learning model based on the respective set of model updates from each respective client of the plurality of clients further comprises: pruning the updated global machine learning model based on updated gate probabilities for the global machine learning model and a threshold gate probability value.

Clause 8: A method for performing federated learning of a machine learning model, comprising: receiving from a server managing federated learning of a global machine learning model: a subset of model elements from a set of model elements for the global machine learning model; and a set of gate probabilities, wherein each gate probability of the set of gate probabilities is associated with one model element of the subset of model elements; generating a set of model updates based on training a local machine learning model based on the set of model elements and the set of gate probabilities; and transmitting to the server a set of model updates.

Clause 9: The method of Clause 8, wherein the subset of model elements comprises a subset of weights associated with edges connecting nodes in the global machine learning model.

Clause 10: The method of Clause 9, wherein the set of model updates comprises: a set of weight gradients associated with the local machine learning model; and a set of gate probability gradients associated with the local machine learning model.

Clause 11: The method of Clause 9, wherein the set of model updates comprises: a set of weight gradients associated with the local machine learning model; and a binary gate variable value associated with each weight gradient of the set of weight gradients.

Clause 12: The method of any one of Clause 8-11, wherein the subset of model elements comprises a subset of nodes in the global machine learning model.

Clause 13: The method of any one of Clauses 8-11, wherein the subset of model elements comprises a subset of channels in a convolution filter of the global machine learning model.

Clause 14: The method of any one of Clauses 8-13, further comprising: receiving a final set of model elements from the server, wherein the final set of model elements corresponds to a pruned global machine learning model.

Clause 15: A processing system, comprising: a memory comprising computer-executable instructions; and one or more processors configured to execute the computer-executable instructions and cause the processing system to perform a method in accordance with any one of Clauses 1-14.

Clause 16: A processing system, comprising means for performing a method in accordance with any one of Clauses 1-14.

Clause 17: A non-transitory computer-readable medium comprising computer-executable instructions that, when executed by one or more processors of a processing system, cause the processing system to perform a method in accordance with any one of Clauses 1-14.

Clause 18: A computer program product embodied on a computer-readable storage medium comprising code for performing a method in accordance with any one of Clauses 1-14.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for performing federated learning of a machine learning model, comprising:
receiving at a device from a server managing federated learning of a global machine learning model:
a subset of model elements from a set of model elements for the global machine learning model; and
a set of gate probabilities, wherein each gate probability of the set of gate probabilities is associated with one model element of the subset of model elements;
generating by the device a set of model updates based on training a local machine learning model based on the set of model elements and the set of gate probabilities; and
transmitting from the device to the server a set of model updates.

2. The method of claim 1, wherein the subset of model elements comprises a subset of weights associated with edges connecting nodes in the global machine learning model.

3. The method of claim 2, wherein the set of model updates comprises:
a set of weight gradients associated with the local machine learning model; and
a set of gate probability gradients associated with the local machine learning model.

4. The method of claim 2, wherein the set of model updates comprises:
a set of weight gradients associated with the local machine learning model; and
a binary gate variable value associated with each weight gradient of the set of weight gradients.

5. The method of claim 1, wherein the subset of model elements comprises a subset of nodes in the global machine learning model.

6. The method of claim 1, wherein the subset of model elements comprises a subset of channels in a convolution filter of the global machine learning model.

7. The method of claim 1, further comprising: receiving at the device a final set of model elements from the server, wherein the final set of model elements corresponds to a pruned global machine learning model.

8. A processing system, comprising:
a memory comprising computer-executable instructions; and
one or more processors configured to execute the computer-executable instructions and cause the processing system to:
receive from a server managing federated learning of a global machine learning model:
a subset of model elements from a set of model elements for the global machine learning model; and
a set of gate probabilities, wherein each gate probability of the set of gate probabilities is associated with one model element of the subset of model elements;
generate a set of model updates based on training a local machine learning model based on the set of model elements and the set of gate probabilities; and
transmit to the server a set of model updates.

9. The processing system of claim 8, wherein the subset of model elements comprises a subset of weights associated with edges connecting nodes in the global machine learning model.

10. The processing system of claim 9, wherein the set of model updates comprises:
a set of weight gradients associated with the local machine learning model; and
a set of gate probability gradients associated with the local machine learning model.

11. The processing system of claim 9, wherein the set of model updates comprises:
a set of weight gradients associated with the local machine learning model; and
a binary gate variable value associated with each weight gradient of the set of weight gradients.

12. The processing system of claim 8, wherein the subset of model elements comprises a subset of nodes in the global machine learning model.

13. The processing system of claim 8, wherein the subset of model elements comprises a subset of channels in a convolution filter of the global machine learning model.

14. The processing system of claim 8, wherein the one or more processors are further configured to receive a final set of model elements from the server, wherein the final set of model elements corresponds to a pruned global machine learning model.

15. A method for performing federated learning of a machine learning model, comprising:
for each respective client of a plurality of clients and for each training round in a plurality of training rounds:
generating, by a server, a subset of model elements for the respective client based on sampling a gate probability distribution for each model element of a set of model elements for a global machine learning model;
transmitting from the server to the respective client:
the subset of model elements; and
a set of gate probabilities based on the sampling, wherein each gate probability of the set of gate probabilities is associated with one model element of the subset of model elements;
receiving at the server from each respective client of the plurality of clients a respective set of model updates; and
updating, by the server, the global machine learning model based on the respective set of model updates from each respective client of the plurality of clients.

16. The method of claim 15, wherein the subset of model elements comprises a subset of weights associated with edges connecting nodes in the global machine learning model.

17. The method of claim 16, wherein the respective set of model updates comprises:
a set of weight gradients associated with a local machine learning model trained by the respective client; and
a set of gate probability gradients associated with the local machine learning model trained by the respective client.

18. The method of claim 16, wherein the respective set of model updates comprises:
a set of weight gradients associated with a local machine learning model trained by the respective client; and
a binary gate variable value associated with each weight gradient of the set of weight gradients.

19. The method of claim 15, wherein the subset of model elements comprises a subset of nodes in the global machine learning model.

20. The method of claim 15, wherein the subset of model elements comprises a subset of channels in a convolution filter of the global machine learning model.

21. The method of claim 15, wherein updating, by the server, the global machine learning model based on the respective set of model updates from each respective client of the plurality of clients further comprises pruning the updated global machine learning model based on updated gate probabilities for the global machine learning model and a threshold gate probability value.

22. A processing system, comprising:
a memory comprising computer-executable instructions; and
one or more processors configured to execute the computer-executable instructions and cause the processing system to:
for each respective client of a plurality of clients and for each training round in a plurality of training rounds:
generating a subset of model elements for the respective client based on sampling a gate probability distribution for each model element of a set of model elements for a global machine learning model;
transmitting to the respective client:
the subset of model elements; and
a set of gate probabilities based on the sampling, wherein each gate probability of the set of gate probabilities is associated with one model element of the subset of model elements;
receiving from each respective client of the plurality of clients a respective set of model updates; and
updating the global machine learning model based on the respective set of model updates from each respective client of the plurality of clients.

23. The processing system of claim 22, wherein the subset of model elements comprises a subset of weights associated with edges connecting nodes in the global machine learning model.

24. The processing system of claim 23, wherein the respective set of model updates comprises:
a set of weight gradients associated with a local machine learning model trained by the respective client; and
a set of gate probability gradients associated with the local machine learning model trained by the respective client.

25. The processing system of claim 23, wherein the respective set of model updates comprises:
a set of weight gradients associated with a local machine learning model trained by the respective client; and
a binary gate variable value associated with each weight gradient of the set of weight gradients.

26. The processing system of claim 22, wherein the subset of model elements comprises a subset of nodes in the global machine learning model.

27. The processing system of claim 22, wherein the subset of model elements comprises a subset of channels in a convolution filter of the global machine learning model.

28. The processing system of claim 22, wherein in order to update the global machine learning model based on the respective set of model updates from each respective client of the plurality of clients, the one or more processors are further configured to prune the updated global machine learning model based on updated gate probabilities for the global machine learning model and a threshold gate probability value.
